(19) United States
(12) Patent Application Publication
(10) Pub. No.: US 2005/0133554 A1
(43) Pub. Date: Jun. 23, 2005

(54) Personal emergency notification system

(76) Inventor: Deborah Maupin, Maryville, TN (US)

Correspondence Address: LUEDEKA, NEELY & GRAHAM, P.C., P O BOX 1871, KNOXVILLE, TN, 37901, US

(21) Appl. No.: 11/003,950

(22) Filed: Dec. 3, 2004

Related U.S. Application Data
(60) Provisional application No. 60/528,364, filed on Dec. 10, 2003.

(51) Int. Cl. B60R 7/05

(52) U.S. Cl. 224/312

(57) ABSTRACT

A personal emergency notification system provides contact information to emergency personnel in the event of an accident. A visor pouch attaches to a visor of a vehicle. The pouch includes fastener for securing an opening in the pouch, and included within the pouch is a visor card for storing emergency contact information, a wallet card sized to fit in a wallet, and a marker for writing on the visor and wallet cards. Reflective decals are provided for adhering to the outside of a vehicle to alert emergency response personnel that emergency contact information can be found in the vehicle. Blank white adhesive strips are provided and sized to fit on the visor and wallet cards to provide updated emergency contact information, and instructions are also provided with the kit providing information for using the emergency contact system.

### CROSS REFERENCE TO RELATED APPLICATIONS

This application claims the benefit of U.S. Provisional Application No. 60/528,364, filing date Dec. 10, 2003.

### FIELD

This invention relates to the field of providing contact information during an emergency.

### BACKGROUND

Vehicle accidents occur frequently and when least expected. These collisions can cause serious personal injuries to both drivers and passengers, which require prompt medical and emergency care. Often, the injuries include unconsciousness or inability to communicate with rescue personnel which hinders contacting friends and family of the injured vehicle occupants. Often the only contact information found at an accident scene is a driver's license, listing the driver's; however, having only one contact phone number available, significantly decreases the likelihood of notifying anyone within a short period of time. The inability to make quick contact in an emergency situation may lead to numerous problems including the absence of family members when life-altering medical decisions need to be made for an unconscious patient.

Currently, the only contact information emergency personnel may expect to find at an accident site is a driver's license and a car registration. Both of these forms of contact information cause difficulties because they are not placed in the same location by all drivers. A driver's license could be a loose piece of identification placed in the driver's pocket, wallet, armrest, cup-holder, or many other places within the vehicle. Even more dangerous and frustrating, some drivers forget to bring their driver's licenses on every trip. The other common form of identification is the car registration. The registration may also be placed in many different locations in the vehicle or may not be present. Both of these common forms of identification may not, and usually do not, provide sufficient contact information to quickly locate a driver's family and friends. Driver's license information may lead to one contact phone number and a car registration may lead to another contact phone number. Both phone numbers may be the driver's own personal phone number, in which case the chance of finding friends and family are small.

### SUMMARY

What is needed is an emergency notification system, which allows emergency personnel to quickly contact the loved ones of an injured driver or passenger. A system that standardizes the placement of contact information is needed to further increase the chances of emergency personnel contacting family and friends. Notification is needed that easily informs emergency personnel that contact information is present. Also, a need exists for multiple contact numbers for various loved ones, and an easy means for editing contact information contained in the system. The above and other needs are met by providing a personal emergency notification system

Thus, in accordance with one embodiment, a system (or kit) provides emergency contact information. As part of the system, a sturdy, water-resistant, nylon pouch is configured to attach to the visor or sunshade of a vehicle. The pouch has an inside and an outside and an opening for accessing the inside. The opening has two opposing edges which have hoop and loop material attached so that the opening can be secured. The pouch also has opposing first and second sides as well as opposing top and bottom sides. In addition, the pouch has a front side for displaying logos or other printed matter. The corresponding back side of the pouch abuts the vehicle's visor.

First and second elastic bands are provided for attaching the pouch to the visor. The first elastic band has a first end and a second end, where the first end attaches to the back side of the pouch near the top and first sides of the pouch and the second end attaches to the back side of the pouch near the bottom and first sides of the pouch. Similarly, the second elastic band has first and second ends, where the first end attaches to the back side of the pouch near the top and second sides of the pouch and the second end attaches to the back side of the pouch near the bottom and second sides of the pouch. Thus, the elastic bands are configured to attach the pouch to the visor.

A visor card is also provided. It has a front side and back side, where each side contains contact information fields for storing emergency contact information. The visor card is sized to fit within the inside of the pouch.

Similar to the visor card, a wallet card is provided. It also has both a front and back side, these sides containing contact information fields for storing emergency contact information. Unlike the visor card, the wallet card is sized to fit within a wallet.

A marker is provided as part of the system. The marker is a fine tip permanent ink marker, having ink appropriate for writing on the visor and wallet cards.

The system also provides reflective decals having a front reflective side for displaying logos or other printed matter and a bottom adhesive side for permanently adhering the decals to the outside of a vehicle to alert emergency response personnel that emergency contact information can be found within the vehicle.

Blank, white adhesive strips are included in the system. These strips are sized to fit over the contact information fields on the visor and wallet cards so that updated information can be provided on those cards.

Finally, written and video format instructions for using the emergency contact information system are provided as part of the system.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a a picture of the kit in its entirety;

FIG. 2 is a picture of the front of the visor pouch;

FIG. 3 is a picture of the back of the visor pouch;

FIG. 4 is a picture of the bottom of the visor pouch;

FIG. 5 is a picture of the left proximal side of the visor pouch;

FIG. 6 is a picture of the right proximal side of the visor pouch illustrating the opening of the visor pouch;

FIG. 7 is a picture of the reflective decals;

FIG. 8 is a picture of the contents and installation instructions;

FIG. 9 is a picture of the fine tip permanent marker;

FIG. 10 is a picture of the visor card and the wallet card;

FIG. 11 is a close-up picture of the visor card;

FIG. 12 is a picture of the visor card and the replacement adhesive strips;

FIG. 13 is a picture of the backs of the visor card and the wallet card; and

FIG. 14 is a close-up picture of the back of the visor card.

### DETAILED DESCRIPTION

The present invention relates to a personal emergency notification system for providing immediate and thorough contact information to emergency personnel treating injured vehicle crash victims at the scene of an accident.

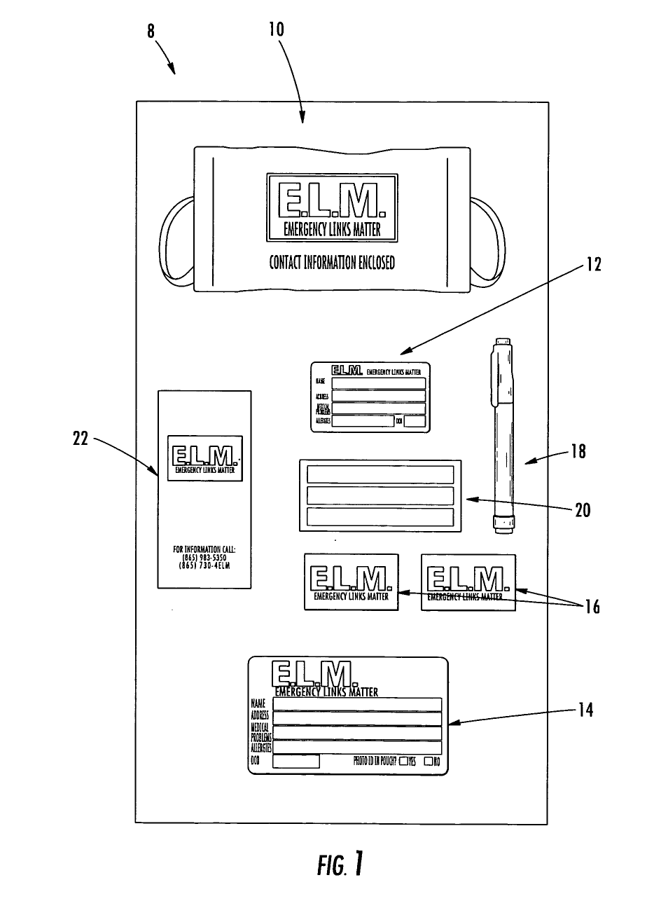

FIG. 1 is a picture of the preferred embodiment of a system 8 which contains a visor pouch 10, a wallet card 12, a visor card 14, two reflective decals 16, a fine tip permanent marker 18, replacement adhesive strips 20, and contents and installation instructions 22. The visor pouch 10 is for holding the visor card 14, the fine tip permanent market 18, the replacement adhesive strips 20, and the contents and installation instructions 22 after installed in a vehicle. The visor pouch 10 also provides storage for the reflective decals 16 and the wallet card 12 before they are removed for use.

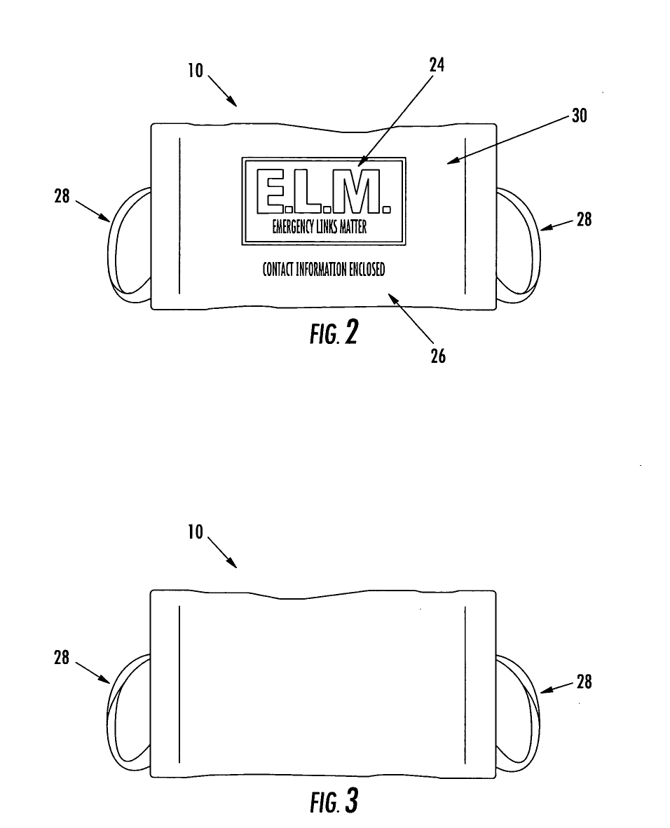

FIG. 2 is a picture of the front view of the visor pouch 10 clearly showing the “E.L.M. Emergency Links Matter” logo 24. Also printed conspicuously on the front of the visor pouch 10 are the words “Contact Information Enclosed” 26, which indicate to emergency personnel that victim contact information is contained within the visor pouch 10. Two elastic attachment straps 28 are shown hanging from the sides of the visor pouch 10. These straps 28 are used to secure the visor pouch 10 to the driver side sun visor in a vehicle. Although difficult to view from a front angle, the opening 30 of the visor pouch 10 is indicated. The opening 30 allows for the above mentioned items to be secured in the visor pouch 10.

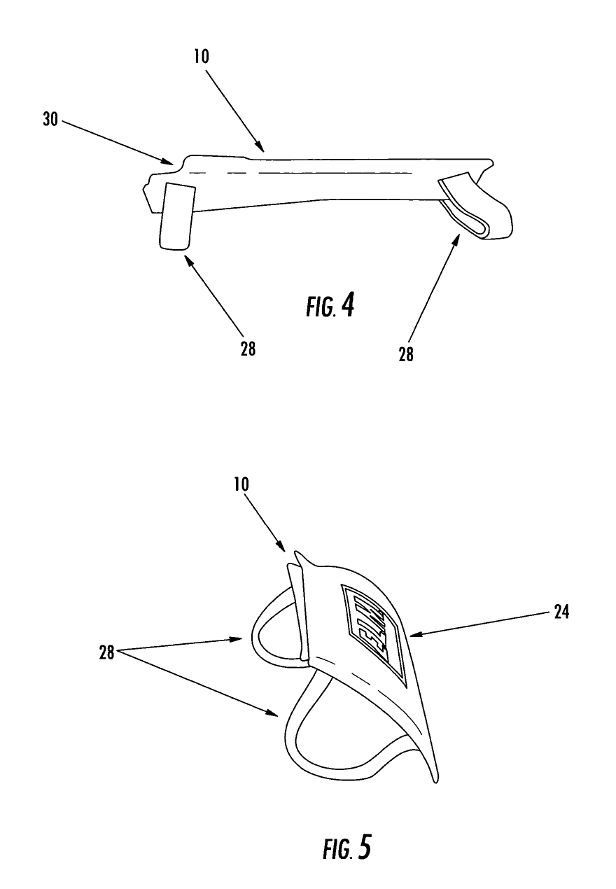

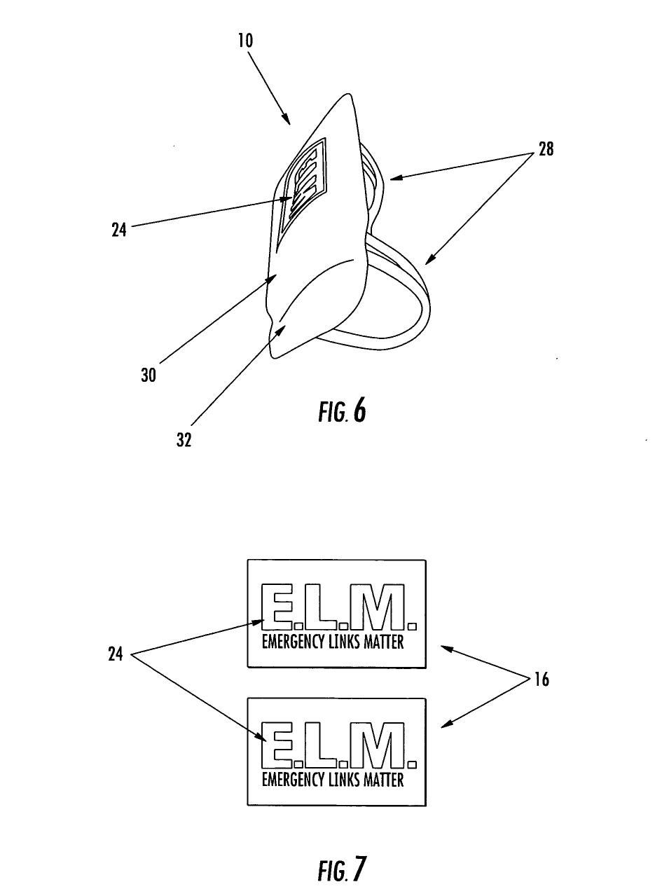

FIG. 3 is a view of the visor pouch 10 from the rear. This view portrays the elastic attachment straps 28, each attached to the top and bottom of the back of the visor pouch 10 respectively. FIG. 4 is a top view of the visor pouch 10 which shows the opening 30 and the elastic attachment straps 28. FIG. 5 is a left side view of the visor pouch 10, which shows the elastic attachment straps and the “E.L.M. Emergency Links Matters” logo 24. Similarly, FIG. 6 is a right side view of the visor pouch 10, which also shows the elastic attachment straps 28 and the “E.L.M. Emergency Links Matter” logo 24. The opening 30 is securely closed by the hook and loop coupling 32.

FIG. 7 shows the two reflective decals 16 which portray the “E.L.M. Emergency Links Matter” logo 24. The reflective decals 16 are intended to be placed at conspicuous locations on the outside of the vehicle such as, the right rear bumper and the left front (driver's side) car windshield. The two reflective decals 16 have reflective finishes on the front sides, which provide for easy recognition by emergency personnel that the car contains a personal emergency notification system. The reflective decals 16 also have an adhesive posterior for easy application to the vehicle.

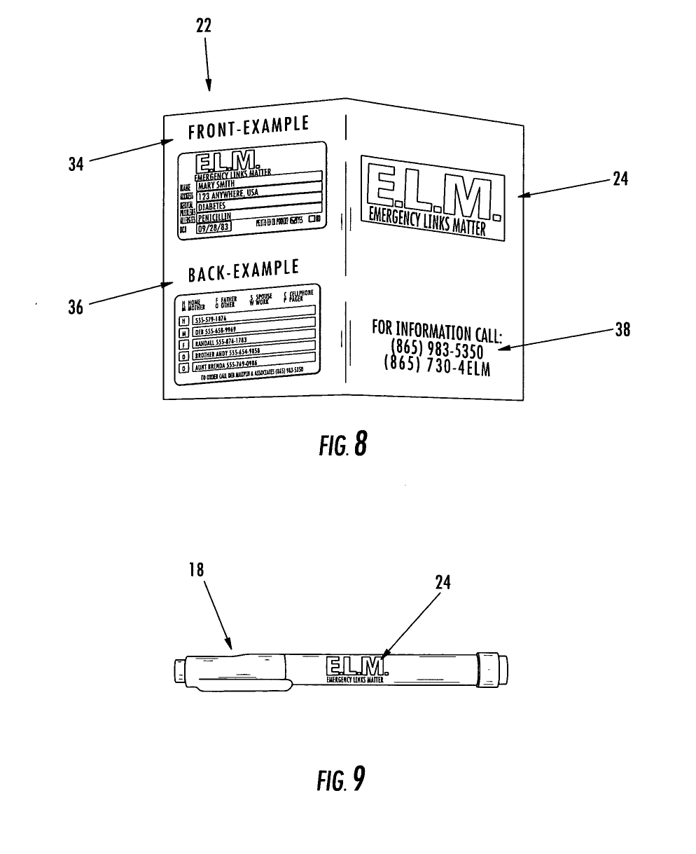

FIG. 8 shows the contents and installation instructions 22, which have the “E.L.M. Emergency Links Matter” logo 24 and contact numbers for more information regarding E.L.M. 38 on the front face. The back face of the contents and installation instructions 22 shows a front-example 34 of a completed visor card 24 and a back-example 36 of a completed visor card 24. The examples 34 and 36, while shown for the visor card 24, may also be used as assistance in completing the wallet card 12 as the two cards are substantially similar. The inside pages of the contents and installation instructions 22 include a table of contents, instructions on installation of the visor pouch 10, instructions on filing out the visor card 24 and the wallet card 12, instructions on placing the reflective decals 16, and instructions on using the replacement adhesive strips 20. FIG. 9 shows the fine tip permanent marker 18 with the “E.L.M. Emergency Links Matter” logo 24 printed on the side. This fine tip permanent marker 18 is for completing the information fields 40 through 50 on the visor card 14 and the wallet card 12.

FIG. 10 shows both the visor card 14 and the wallet card 12. The two cards' relative sizes may be determined from this figure. The visor card 14 is designed to fit into the visor pouch 10. It is large and contains large fields 40 through 50 so that easily readable information may be recorded on visor card 14. This allows emergency personnel to find visor card 14 easily due to its large size and read visor card 14 easily due to its large fields 40 through 50. The wallet card 12 is smaller, sized to fit inside a wallet, purse, or similar personal baggage device. Both the visor card 14 and the wallet card 12 have a sharp contrast in color from a bright red background to shining white fields 40 through 50. This also allows for ease in finding both visor card 14 and wallet card 12 and in reading the information contained in the fields 40 through 50.

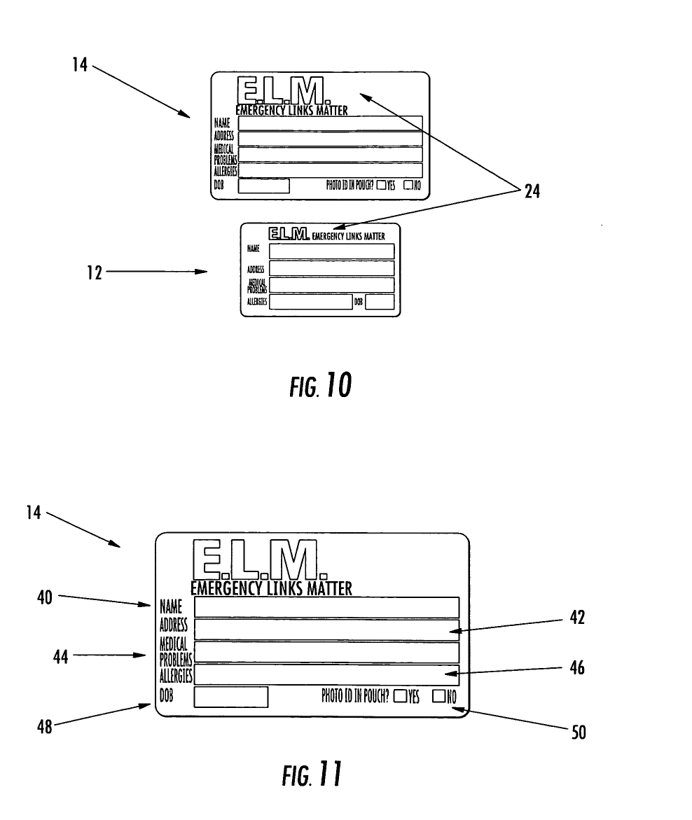

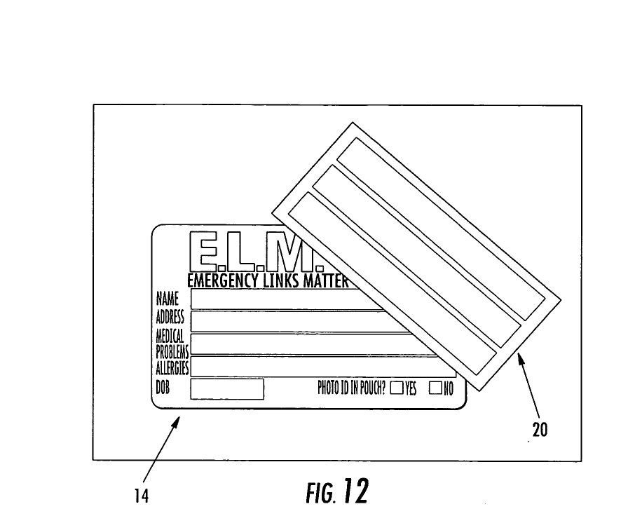

FIG. 11 shows a close-up view of the visor card 14. As stated before, the fields 40 through 48 on the wallet card 12 are substantially similar to those on the visor card 14 so they will only be described once. The major difference is the presence of a “Photo ID in Pouch?” checkbox field 50 on the visor card 14 which is not found on the wallet card 12. “Photo ID in Pouch” checkbox field 50 is useful, allowing emergency personnel to easily know whether to look for a photo ID in the visor pouch 10. This, of course, would be much less useful on the wallet card 12, because a wallet is generally a place where a photo ID would be stored. Thus, space may be saved on the wallet card 12 by removing “Photo ID in Pouch?” checkbox field 50. The fine tip permanent marker 18 should be used to fill out the fields 40 through 50 on both the visor card 14 and the wallet card 12. Both visor card 14 and wallet card 12 contain fields 40 through 48, individually titled “Name” field 40, “Address” field 42, “Medical Problems” field 44, “Allergies” field 46, and “DOB” field 48. The contents and installation instructions 22 provides instructions on filling out all of fields 40 through 50. The “Name” field 40 should be filled out with the driver's complete name. The “Address” field 42 should be filled out with the driver's complete address. The “Medical Problems” field 44 should be filled out with any medical problems the driver has, for example diabetes or hypertension. The “Allergies” field 46 should be filled out with a list of any allergies the driver may have. The “DOB” field 48 should be filled out with the drivers date of birth, for example “2/13/55.” Of course, some of this information may change with time, so replacement adhesive strips 20 may be used to keep all information updated. FIG. 12 shows the visor card 14 and the adhesive strips 20. Adhesive strips 20 are the same white color as the fields 40 through 50 and the information fields 54, discussed below. When contact information changes, for example, a new “Medical Problem” develops, the system 8 user can place an adhesive strip 20 over field 44 and use marker 18 to write the new information. The outdated information is thus replaced by more current, up-to-date information.

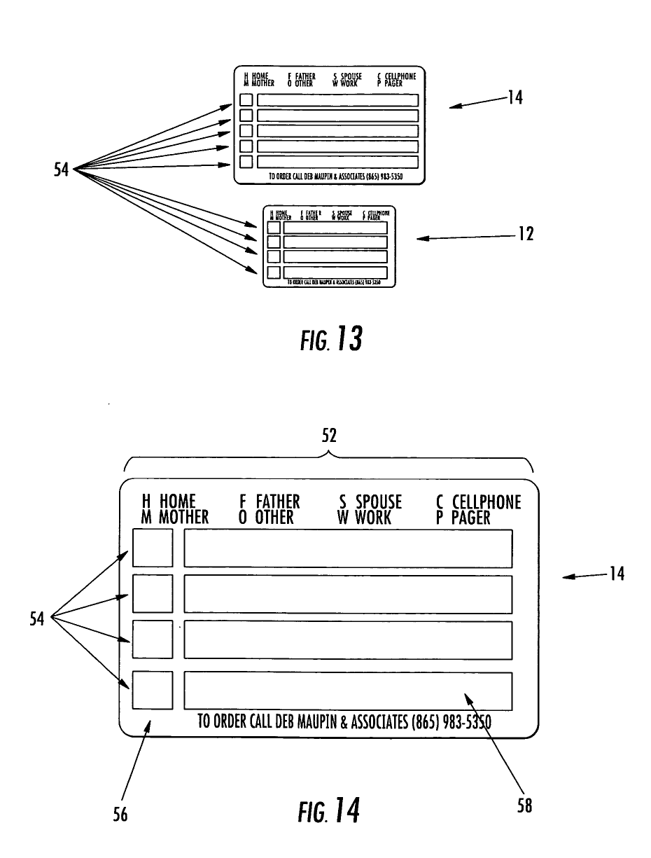

Similar to the front of the visor card 14 and the wallet card 12, the back of both cards contain shiny white contact information fields 54 set on a background of bright red. The red indicates the importance of the cards and makes them easy for emergency personnel to find, while the white contact information fields 54 make the information easy for emergency personnel to read. FIG. 13 shows the back side of both the visor card 14 and the wallet card 12, and the contrast in size may again be noted. As can be seen, the visor card 14, due to its larger size is able to house five contact information fields 54, whereas the wallet card 12 only has four contact information fields 54. Otherwise, the two cards are substantially similar. FIG. 14 shows a blown-up view of the back of the wallet card 12, which of course, is representative of the visor card 14. Along the top of the card is a key 52, with possible contact descriptions and their abbreviations—the first letter of each possible entry. Possible contact descriptions include “Home”, “Father”, “Spouse”, “Cell phone”, “Mother”, “Other”, “Work”, and “Pager”; each with a respective abbreviation of H, F, S, C, M, O, W, and P, corresponding to the first letter of the contact description. These abbreviations may be used singularly or they may be combined as shown in the back-example 36 in FIG. 8, which shows “M/C” for Mother's Cell phone in one field 56. The contact information fields 54 are further divided into two separate fields: a smaller abbreviated contact description 56 located in line with a larger corresponding phone number entry location 58. The phone number entry locations 58 may also be used to write in additional contact information such as names or contact descriptions as seen in the back-example 36 in FIG. 8 such as “Randall” or “Brother Andy.”

The foregoing description of a preferred embodiment for this invention has been presented for purposes of illustration and description. It is not intended to be exhaustive or to limit the invention to the precise form disclosed. Obvious modifications or variations are possible in light of the above teachings. The embodiment is chosen and described in an effort to provide the best illustrations of the principles of the invention and its practical application, and to thereby enable one of ordinary skill in the art to utilize the invention in various embodiments and with various modifications as is suited to the particular use contemplated. All such modifications and variations are within the scope of the invention as determined by the future appended claims when interpreted in accordance with the breadth to which they are fairly, legally, and equitably entitled.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A kit for providing emergency contact information comprising:
a visor pouch for attaching to a visor of a vehicle, the pouch having:
a) an inside and an outside and an opening having opposing first and second edges for accessing the inside,
b) a fastener for detachably and reattachably securing the first and second sides of the opening together,
c) opposing first and second sides,
d) opposing top and bottom sides,
e) a front side for displaying indications of the contents of the pouch,
f) a visor fastener for attaching the pouch to a visor
a visor card sized to fit within the pouch for storing emergency contact information,
a wallet card sized to fit within a wallet for storing emergency contact information,
a marker for writing on the visor and wallet cards,
reflective decals for adhering to the outside of a vehicle to alert emergency response personnel that emergency contact information can be found in the vehicle, and
instructions for using the emergency contact information system

2. The kit of claim 1 further comprising:
blank, white adhesive strips sized to fit on the visor and wallet cards to provide updated emergency contact information.

3. The kit of claim 1 wherein the pouch is configured to store the markers, cards, reflective decals, adhesive strips and instructions.

4. The kit of claim 1 wherein the contact information fields found on the front side of the visor and wallet cards include a “Name” field, and “Address” field, a “Medical Problems” field, an “Allergies” field and a “DOB” field.

5. The kit of claim 1 wherein the contact information fields found on the front side of the visor card additionally includes a “Photo ID” field.

6. The kit of claim 1 wherein the back side of the visor and wallet cards contain multiple contact information fields and a key of possible contacts and their abbreviations.

7. The kit of claim 6 wherein the key of possible contacts include “Home,” “Father,” “Spouse,” “Cell phone,” “Mother,” “Other,” “Work” and “Pager.”

8. The kit of claim 6 wherein the abbreviations of the possible contacts are the first letter of each contact.

9. The kit of claim 6 wherein the contact information fields contain a contact description and a corresponding phone number entry location.

10. The kit of claim 6 wherein the visor card contains 5 contact information fields.

11. The system of claim 6 wherein the wallet card contains 4 contact information fields.

12. A kit for providing emergency contact information comprising:
a sturdy, water-resistant, visor pouch for attaching to a visor of a vehicle, the pouch having:
an inside and an outside and an opening
opposing first and second edges for accessing the inside,
a fastener for detachably and reattachably securing the first and second edges of the opening,
opposing first and second sides,
opposing top and bottom sides,
a front side for displaying indicia including E.L.M. EMERGENCY LINKS MATTER, and
a back side which abuts the visor,
a first elastic band having a first end and a second end, where the first end attaches to the back side of the pouch near the top and first sides of the pouch and the second end attaches to the back side of the pouch near the bottom and first sides of the pouch, and
a second elastic band also having a first end and a second end where the first end attaches to the back of the pouch near the top and second sides of the pouch and the second end attaches to the back of the pouch near the bottom and second sides of the pouch, such that the elastic bands are configured to attach the pouch to the visor,
a visor card having a front side and a back side containing contact information fields for storing emergency contact information, sized to fit within the inside of the pouch,
a wallet card having a front side and a back side containing contact information fields for storing emergency contact information sized to fit within a wallet,
a permanent ink marker, the marker having ink appropriate for writing on the visor and wallet cards,
reflective decals having a front reflective side printed with indicia including E.L.M. EMERGENCY LINKS MATTER and a bottom adhesive side for permanently adhering the decals to the outside of a vehicle to alert emergency response personnel that emergency contact information can be found in the vehicle,
blank, white adhesive strips sized to fit over the contact information fields on the visor and wallet cards to provide updated information, and
instructions for using the emergency contact information system.
